(19) United States
(12) Patent Application Publication
(10) Pub. No.: US 2015/0177050 A1
(43) Pub. Date: Jun. 25, 2015

(54) LIQUID LEVEL GAUGE WITH FLOAT GUIDES

(71) Applicant: Texas LFP, LLC, Dallas, TX (US)

(72) Inventor: Carl Alan Taylor, Frisco, TX (US)

(21) Appl. No.: 14/515,022

(22) Filed: Oct. 15, 2014

Related U.S. Application Data
(60) Provisional application No. 61/918,662, filed on Dec. 20, 2013.

(51) Int. Cl. G01F 23/58

(52) U.S. Cl. CPC G01F 23/58

(57) ABSTRACT

A liquid level gauge includes a mounting head and a sensor assembly with a support tube that extends into a tank from the mounting head. A gauge rod is positioned in a support tube for selective movement out of the tank for visually determining the liquid level. A magnet is associated with the gauge rod and couples with a magnet associated with a float that slides along the support tube so that the gauge rod and float are selectively coupled together. A pair of spaced bearings are mechanically retained within the float structure with retaining rings and spaced projections located on opposite sides of each bearing. In this manner, the float slides more freely along the support tube, allowing more accurate readings while minimizing failure.

### CROSS-REFERENCE TO RELATED APPLICATIONS

This application claims the benefit of U.S. Provisional Application No. 61/918,662 filed on Dec. 20, 2013, the disclosure of which is hereby incorporated by reference.

### BACKGROUND OF THE INVENTION

This invention relates to liquid level gauges, and more particularly to a liquid level gauge having a magnetic float that moves in response to a change in liquid level.

U.S. Pat. No. 3,815,416 to Dean et al. discloses a prior art apparatus for indicating the level of liquid in a tank car. The apparatus includes a float encircling a tube extending down into the tank. The float is magnetically coupled to a gauging rod which bears indicia representing the level of liquid in the tank. The gauging rod is normally retained inside the tube via an upper cover removably secured to the tank opening. When it is desirous to check the liquid level within the tank, the cover is removed and the gauge rod is manually raised until it magnetically couples with the float. Depending on the liquid level, the length of the gauge rod extending out of the tank will change. The user can ascertain the level in the tank by the visible indicia located on the rod. The apparatus also has a mechanism for automatically visually and audibly alerting the user when the level has reached a particular level, such as a near full condition when the tank is being filled. This mechanism includes a tower and a series of reed switches mounted on the tank above the rod opening. A magnet attached to the top of the rod moves past the reed switches to serially actuate them as the tank is filled.

Although such systems are adequate for their intended purpose, the sliding connection between the float and support tube can become worn, resulting in vibration or rattling between the support tube and the float when movement of the fluid in the tank may occur, such as during transportation of the tank and/or varying the fill level of the tank during use. Such interaction not only causes undesirable noise, but can lead to inaccurate measurement results and mechanical failure of the liquid level apparatus. It would therefore be desirable to overcome one or more disadvantages associated with prior art liquid level devices.

### SUMMARY OF THE INVENTION

In accordance with one aspect of the invention, a liquid level gauge for determining the level of liquid within a container includes a mounting head adapted for connection to the container, and a sensor assembly adapted to extend into the container from the mounting head. The sensor assembly comprises a support tube extending downwardly from the mounting head; a gauge rod positioned in the support tube for selective movement out of the tank for visually determining the liquid level; a first magnet connected to the gauge rod; and a float assembly that slides along the support tube. The float assembly includes a float surrounding the support tube for sliding therealong in response to a change in liquid level; a second magnet for selective coupling to the first magnet so that the gauge rod and float are selectively coupled together; at least a first bearing positioned in the float and surrounding the support tube for sliding movement of the float therealong in response to change in liquid level; and at least a first support ring positioned at least adjacent to the first bearing to prevent the first bearing from becoming dislodged from the float.

In accordance with a further aspect of the invention, a float assembly for use in a liquid level gauge having a vertical support tube that extends into a tank for measuring a level of liquid therein comprises a float adapted to surround the vertical support tube for sliding movement therealong in response to a change in liquid level within the tank, the float having a central axis that is adapted to be coincident with a longitudinal axis of the vertical support tube; a central tube extending through the float and being coincident with the central axis thereof, the central tube having a wall with an outer surface and an inner surface defining a central bore that is adapted to surround the support tube; first and second annular projections formed at first and second locations on the central tube, the annular projections extending generally radially inwardly from an inner surface of the central bore; first and second support rings located within the central bore and retained between the annular projections; and a first bearing having a first opening for slidably receiving the support tube and being positioned in the central bore between the first and second support rings to thereby retain the first bearing between the first and second annular projections.

### BRIEF DESCRIPTION OF THE DRAWINGS

The following detailed description of the preferred embodiments of the present invention will be best understood when considered in conjunction with the accompanying drawings, wherein like designations denote like elements throughout the drawings, and wherein:

FIG. 1 is a sectional side view of a liquid level gauge in accordance with one exemplary embodiment of the present invention mounted in a tanker car;

FIG. 2 is an isometric view of a float assembly for use with the liquid level gauge of FIG. 1;

FIG. 3 is an isometric sectional view of the float assembly taken along line 3-3 of FIG. 2;

FIG. 4 is an isometric exploded view of the float assembly in accordance with the invention;

FIG. 5 is an isometric exploded view of a portion of a float assembly in accordance with a further embodiment of the invention;

FIG. 6 is an enlarged sectional view of the complete float assembly of the FIG. 5 embodiment;

FIG. 7 is an isometric view of a float support system in accordance with the invention; and

FIG. 8 is an isometric view of a dampening portion of the float support system of FIG. 7.

It is noted that the drawings are intended to depict only exemplary embodiments of the invention and therefore should not be considered as limiting the scope thereof. It is further noted that the drawings are not necessarily to scale. The invention will now be described in greater detail with reference to the accompanying drawings.

### DETAILED DESCRIPTION OF THE INVENTION

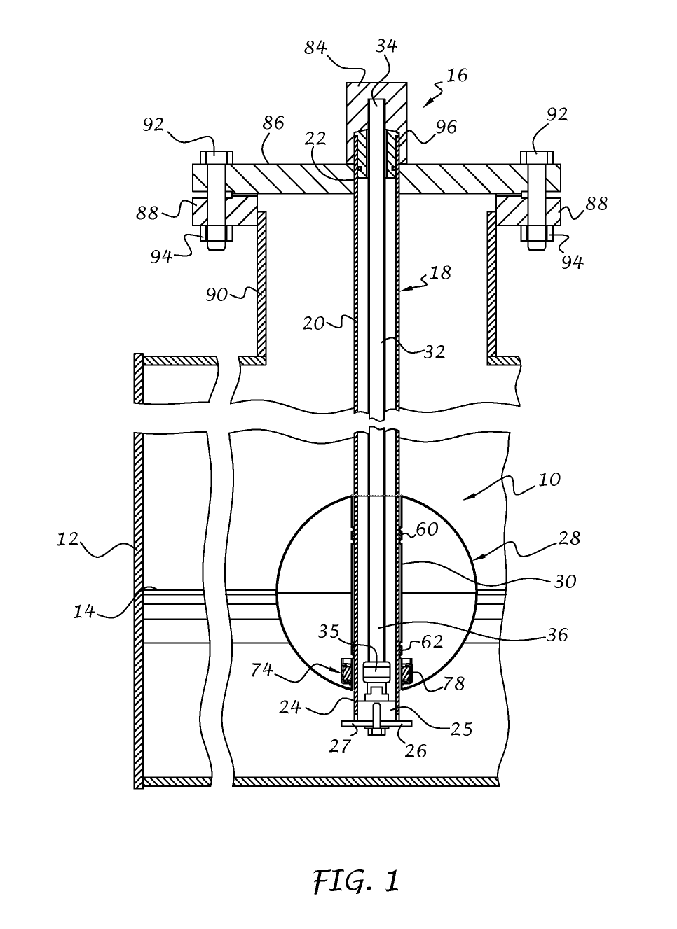

Referring now to the drawings, and to FIG. 1 in particular, a liquid level gauge 10 in accordance with an exemplary embodiment of the present invention is illustrated. The liquid level gauge 10 preferably extends into a tank 12, which may be associated with railroad tanker cars, semi-trailer tankers, large stationary storage tanks, or any other container for holding and/or transporting a liquid 14 where it is desirous to determine the level of liquid within the tank.

The gauge 10 preferably includes a mounting head assembly 16 and an elongate sensing probe assembly 18 connected to the mounting head assembly 16 and extending downwardly therefrom into the tank 12.

The sensing probe assembly 18 preferably senses liquid level in a linear direction and, in accordance with one preferred embodiment of the invention, includes an outer support tube 20 with an upper end 22 that extends into the mounting head assembly 16 and a lower end 24 that terminates at a support member 26 located at or near the bottom of the tank 12. A magnetic float assembly 28 is preferably spherically-shaped and includes a central tube 30 with a central bore 31 that is sized to receive the support tube 20 so that the float slides freely therealong. An inner gauge rod 32 is located within the outer support tube 20 and has an upper end 34 that also extends through the mounting head assembly 16 and a lower end 36 fitted with a magnet 35. The support member 26 serves to both seal the support tube 20 from the contents of the tank 12 and provide a lower stop for the gauge rod 32 when the gauge rod is in the rest position. The outer support tube 18 and inner sensor tube 30 are preferably constructed of non-magnetic materials such as plastic, aluminum, composites, and so on. However, it will be understood that any suitable material can be used as long as the components do not interfere with selective magnetic coupling between the gauge rod 32 and the magnetic float assembly 28.

As shown in FIG. 1, the support member 26 can include a shank portion 25 that extends upwardly from a head portion 27 for sealing the lower end 24 of the outer support tube 20 against the ingress of the liquid 14 to be measured.

If desired, an electronic sensor board (not shown) can be provided for electronically determining liquid level within the tank 12, as described in copending provisional application No. 61/876,078 filed on Sep. 10, 2013 (now U.S. application Ser. No. 14/482,573 filed on Sep. 10, 2014, the disclosures of which are hereby incorporated by reference.

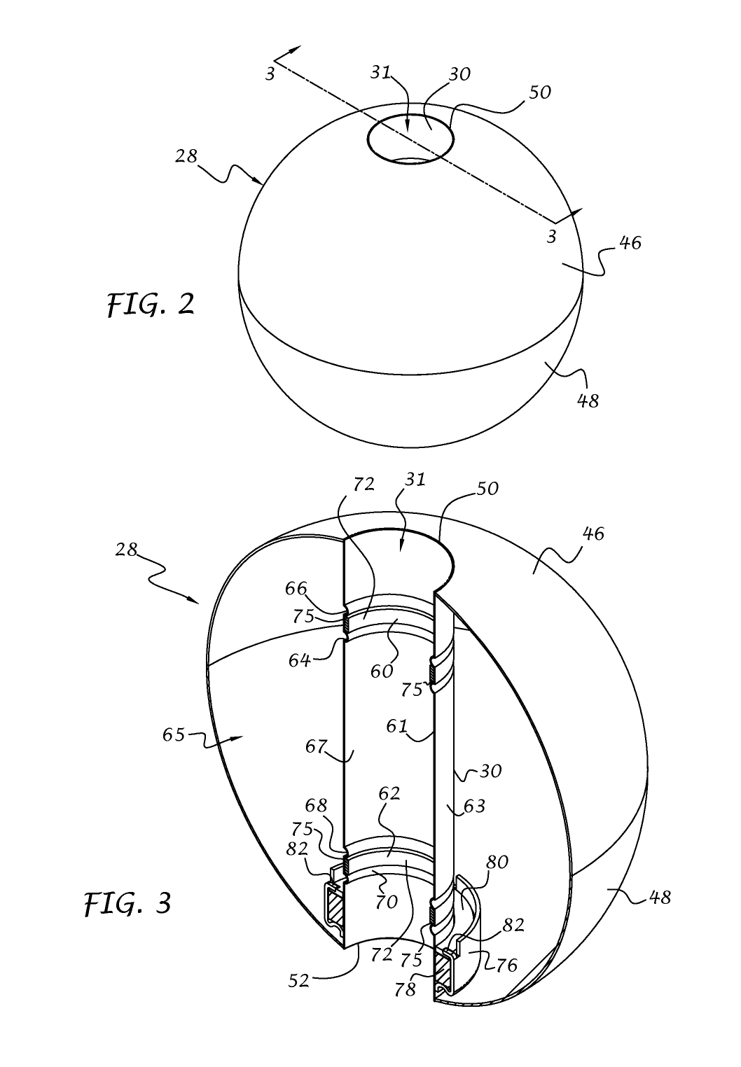

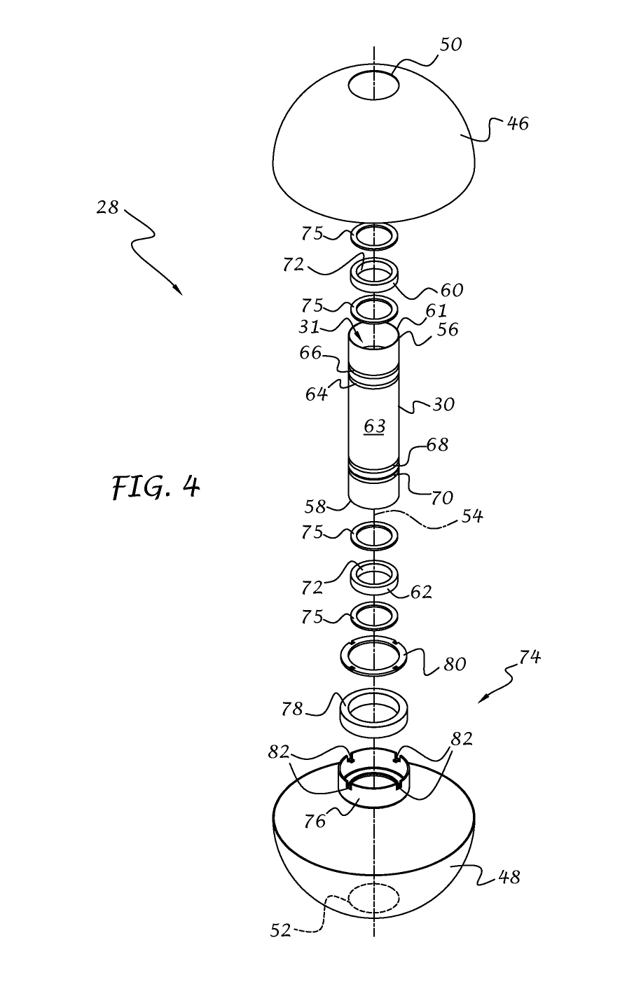

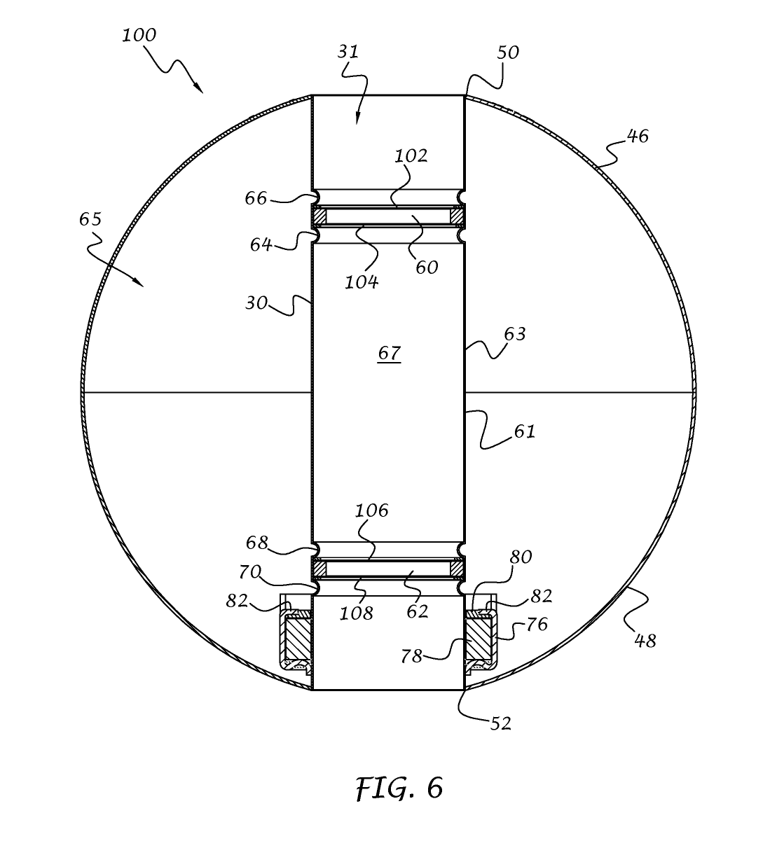

Referring now to FIGS. 2-4, the float assembly 28 preferably includes a spherical body 44 with an upper hemispherically-shaped float portion 46 connected to a lower hemispherically-shaped float portion 48 through well-known connection means such as soldering, welding, adhesive bonding, crimping, mechanical fastening, and so on. An opening 50 is formed in the upper float portion 46 coincident with a central axis 54 thereof (FIG. 4). Likewise, an opening 52 is formed in the lower float portion 48 coincident with the axis 54. The central tube 30 has an upper end 56 connected to the upper float portion 46 coaxially with the opening 50, and a lower end 58 connected to the lower float portion 48 coaxially with the opening 52 through well-known connection means so that the inner space 65 (FIG. 3) of the spherical body 44 is hermetically sealed to prevent the unwanted ingress of fluid into the inner space. An upper annular bearing 60 is received and secured within the upper end 56 of the tube 30. Likewise, a lower annular bearing 62 is received and secured within the lower end 58 of the tube 30. Preferably, the central tube 30 comprises a wall 61 having a thin, circular cross section with an outer surface 63 and an inner surface 67 that defines the central bore 31. An upper set or pair of annular projections 64, 66 are formed in an upper portion of the wall 61 and a lower set or pair of annular projections 68, 70 are formed in a lower portion of the wall 61 of the central tuber 30. The annular projections extend radially inwardly into the bore 31 and are formed by creating annular grooves 64, 66, 68, and 70 on the outer surface 63 of the wall 61 through roll-forming, vacuum-forming, or other known techniques. Due to the relatively thin dimension of the wall 61, the wall is deformed inwardly to form outside annular grooves and inside annular projections, as best shown in FIGS. 3 and 6.

In order to install the upper bearing 60, and as best shown in FIGS. 3 and 4, the groove/projection or crimp 64 is formed in the upper portion of the central tube 30. The inner diameter of the first upper annular projection 64 is less than the outer diameter of the upper annular bearing 60 such that when the bearing is inserted in the tube, it is supported by the first upper annular projection 64. A second upper annular projection or crimp 66 is then formed in the tube 30 above the upper bearing 60 to thereby secure the upper bearing within the upper portion of the tube. Preferably, the first and second upper annular projections are similar in shape and dimension. However, it will be understood that the shape and/or dimension of the annular projections can vary without departing from the spirit and scope of the invention.

Likewise, in order to install the lower bearing 62 in the tube 30, a first lower annular groove/projection or crimp 68 is formed in the lower portion of the central tube 30. The inner diameter of the first lower annular projection 68 is less than the outer diameter of the lower annular bearing 62 such that when the bearing is inserted in the tube, it is supported by the first lower annular projection 68. A second lower annular groove/projection or crimp 70 is then formed in the tube 30 above the lower bearing 62 to thereby secure the lower bearing within the lower portion of the tube.

The upper and lower bearings 60, 62 are preferably constructed of a low friction material, such as nylon, brass, PTFE, and so on, with a central bore 72 thereof surrounding the outer support tube 20 (FIG. 1) and in sliding contact with, or close proximity to, the outer support tube. When softer materials are used for the bearings, such as nylon, PTFE, and so on, each bearing is preferably sandwiched between support rings 75 (shown best in FIG. 4). The support rings 75 are preferably constructed of a harder material, such as metal, in order to prevent the bearings from becoming dislodged. In accordance with a preferred embodiment of the invention, the support rings are constructed of a material with spring-type properties that would allow the rings to deflect inward during assembly and then spring back and seat between the annular bearing projections. One advantage of using PTFE or other softer materials for the bearings, is that they can be pressed past one or more of the annular projections or crimps 64, 66, 68, and/or 70, so that all of the projections may be formed at one time with the bearings and support rings being installed after formation of the projections.

A magnet assembly 74 is connected to the lower end of the central tube 30 and includes a lower cup-shaped support 76, an annular magnet 78 received within the cup-shaped support 76, and an upper cover 80 positioned over the magnet 78 within the support 76. Tabs 82 are located around the perimeter of the support 76 and are bent inwardly over the upper cover 80 to thereby secure the magnet within the support 76. The support 76 is in turn connected to the lower end of the central tube 30 by well-known connection means, such as soldering, welding, adhesive bonding, mechanical fastening, and so on. The magnet 78 can be magnetically coupled with the magnet 35 attached to the gauge rod 32 so that, when the cap 84 of the head assembly 16 is removed, the gauge rod 32 can be manually pulled upwardly until it is magnetically coupled with the float. The gauge rod 32 has a scale (not shown) so that the level of the liquid within the tank 12 can be visually observed in a well-known manner.

The magnet is preferably magnetized on its outer and inner faces such that magnetic flux lines of force are directed perpendicular with respect to the longitudinal extent of the magnet and toward the center of the central tube 30 of the float 28. However, it will be understood that the polarity of the magnets can be reversed and/or the direction of the magnetic flux can be oriented differently without departing from the spirit and scope of the invention.

The components of the float assembly 28 are preferably constructed of rigid materials, such as stainless steel, aluminum or other metals, but can be constructed of other materials, such as closed-cell nitrile material, rubber, plastics, and so on, without departing from the spirit and scope of the invention. It will be understood that the shapes of the float, support tube 20, central tube 30, the mounting head assembly, and so on, are given by way of example only, as other suitable shapes, such as square, triangular, and so on, can be used without departing from the spirit and scope of the invention.

As shown in FIG. 1, the mounting head assembly 16 preferably includes a cover 86 that is removably fastened to a flange 88 of a manway section 90 of the tank 12 via a plurality of bolts 92 and associated nuts 94 as shown, or through other connection means. The end cap 84 is positioned over the cover 86 and is removably connected to the outer support tube 20. The end cap 84 has a central bore 96 that is of sufficient diameter to receive the upper end 22 of the support tube 20.

In use, when the end cap 84 is installed on the cover 86 as shown in FIG. 1, the gauge rod 32 is in the rest position, where the rod may or may not be magnetically coupled to the float assembly 28. In this position, the float is free to travel along the length of the support tube 20, but the gauge rod 32 is restrained from movement. When it is desirous to take a manual measurement of the level of liquid in the tank 12, such as when emptying or filling the tank, the end cap 84 is removed and the gauge rod 32 is pulled out of the tank until it is magnetically coupled with the float assembly 28. The user can then visually observe level markings (not shown) located along the length of the gauge rod to determine the liquid level within the tank 12. The gauge rod 32 can then be magnetically decoupled from the float assembly 28 and pushed back into the support tube 20 and the end cap 84 replaced.

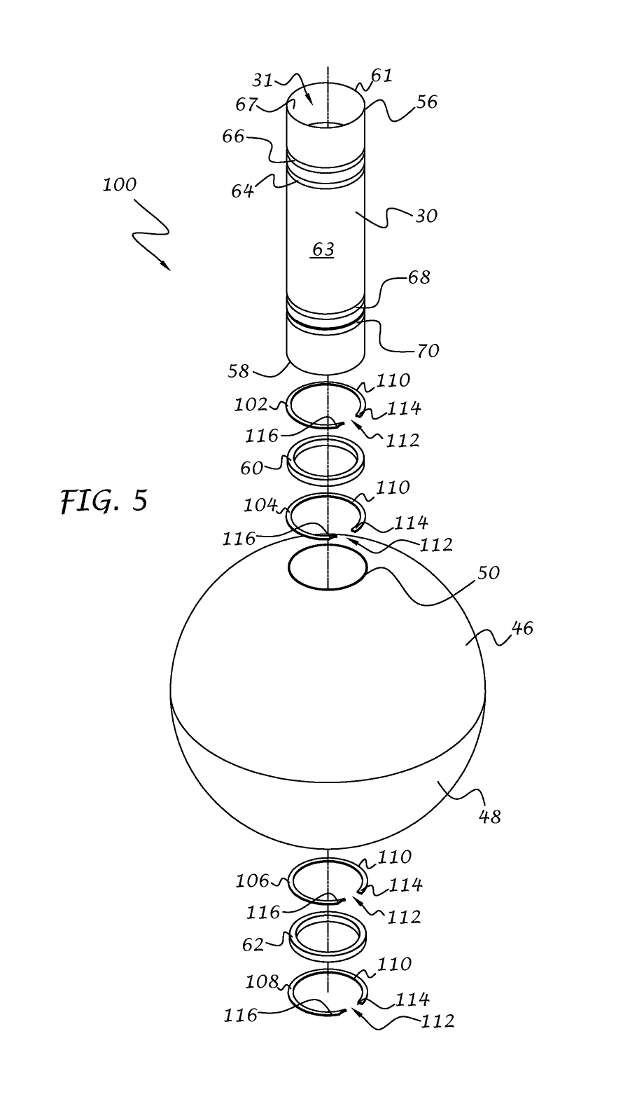

Referring now to FIGS. 5 and 6, a float assembly 100 in accordance with a further embodiment of the invention is illustrated. The float assembly 100 is similar in construction to the float assembly 28 previously described, with the exception that a pair of split retaining rings 102, 104 are located on opposite sides of the upper annular bearing 60 and a pair of split retaining rings 106, 108 are located on opposite sides of the lower annular bearing 62. The split retaining rings 102, 104, 106, and 108 are preferably similar in construction and each includes an annular body 110 and a gap 112 to form opposing ends or fingers 114 and 116. The annular body 110 is preferably flat and the finger 116 narrows towards the gap 112. However, it will be understood that the annular body 110 can be of any suitable shape, and that both fingers can narrow toward the gap, or may have the same width as the annular body, or can be greater in width or of any other suitable shape without departing from the spirit and scope of the invention. Each retaining ring is constructed of a spring-like material, such as spring steel or other suitable materials, laminates, and so on, so that the ends of each retaining ring can move toward each other when a radial compression force is applied and away from each other when the compression force is removed or at least partially removed. In this manner, the retaining rings can contract in diameter during installation and removal in order to fit within the inner diameter of the central tube 30 and clear the annular projections 64, 66, 68, and 70. Likewise, once the retaining rings clear the annular projections during installation, the compression force can be released so that they expand against the inner surface 67 of the central tube, thereby holding the bearings in place between the pairs of annular projections.

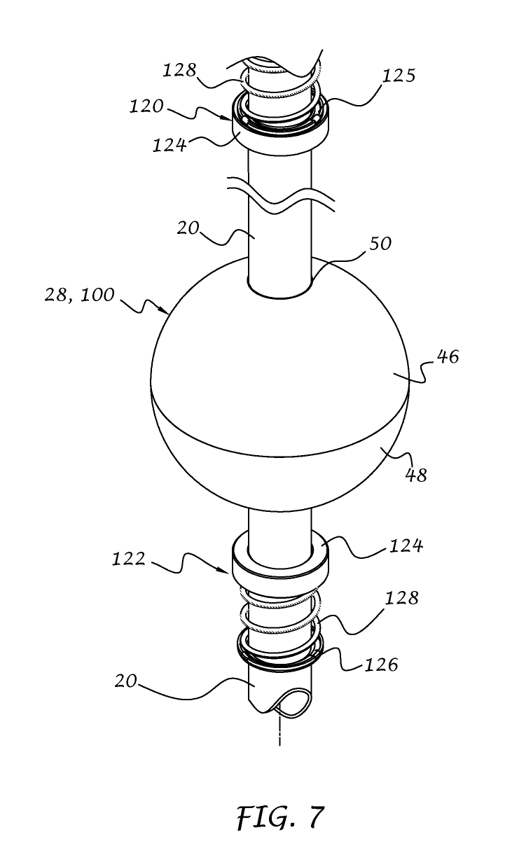

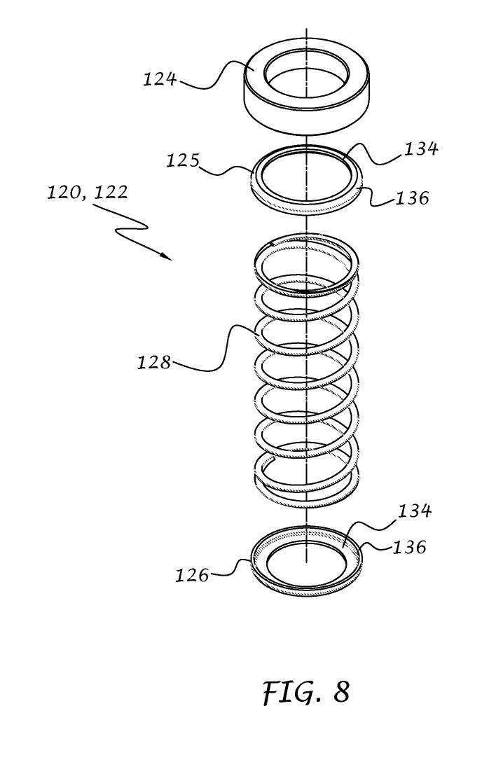

Referring now to FIGS. 7 and 8, an upper dampener assembly 120 is mounted on the support tube 20 at an upper end thereof and a lower dampener assembly 122 is mounted on the support tube 20 at a lower end thereof. The dampener assemblies 120, 122 protect the float assembly 28 or 100 from sudden impact that may occur during tank filling or transportation of a full or empty tank, as well as the potential of the float assembly to slide off the support tube during emptying or filling of the tank. It will be understood that the particular location or height of the upper and lower dampener assemblies with respect to the support tube 20 can greatly vary, and that one or both dampener assemblies can be eliminated, depending on the type of tank the liquid level gauge is installed in.

Each dampener assembly is similar in construction and includes a collar 124 slidably mounted on the support tube 20, a first spring seat 126 mounted at a fixed location with respect to the support tube 20, a second spring seat 25 slidably mounted on the support tube 20 and located within the collar 124, and a compression spring 128 sandwiched between the first and second spring seats 126 and 125, respectively. slidable collar and the fixed spring seat. The compression spring 128 is preferably connected to the spring seat 126 through welding or other connection means. The collar 124 can also be fixedly connected to the spring 128 through welding or other connecting means. However, it is preferred that the spring is free-floating between the first and second spring seats to prevent damage and possible breakage of the spring and other components of the dampener assembly. This is an advantage over prior art welded components since the spring is subjected to undesired stress during operation and can break.

The collar 124 is generally annular in shape with a first wall 130 that contacts the second spring seat 125 which in turn contacts the spring 128 on one side thereof. The other side of the first wall 130 faces the float assembly 28 for contact therewith. A second wall 132 extends axially away from the first wall to form a cup-shaped interior for receiving the second spring seat 125 and one end of the spring 128. Likewise, the first and second spring seats 126, 125 are annular in shape with a first wall 134 that contacts the spring 128 and a second wall 136 that extends axially therefrom to form a cup-shaped interior for receiving the opposite ends of the spring 128.

It will be understood that the term “preferably” as used throughout the specification refers to one or more exemplary embodiments of the invention and therefore is not to be interpreted in any limiting sense. It will be further understood that the term “connect” and its derivatives refers to two or more parts capable of being attached together either directly or indirectly through one or more intermediate members. In addition, terms of orientation and/or position as may be used throughout the specification denote relative, rather than absolute, orientations and/or positions.

It will be appreciated by those skilled in the art that changes could be made to the embodiments described above without departing from the broad inventive concept thereof. By way of example, the mounting head is not limited to the flange-type arrangement as shown and described but can be formed with threads or other known mounting means for connecting the gauge to the container without departing from the spirit and scope of the invention. It will be understood, therefore, that this invention is not limited to the particular embodiments disclosed, but is intended to cover modifications within the spirit and scope of the present invention as defined by the appended claims.

What is claimed is:

1. A liquid level gauge for determining the level of liquid within a container, the liquid level gauge comprising:
a mounting head adapted for connection to the container; and
a sensor assembly adapted to extend into the container from the mounting head, the sensor assembly comprising:
a support tube extending downwardly from the mounting head;
a gauge rod positioned in the support tube for selective movement out of the tank for visually determining the liquid level;
a first magnet connected to the gauge rod;
a float assembly comprising:
a float surrounding the support tube for sliding therealong in response to a change in liquid level;
a second magnet for selective coupling to the first magnet so that the gauge rod and float are selectively coupled together;
at least a first bearing positioned in the float and surrounding the support tube for sliding movement of the float therealong in response to change in liquid level; and
at least a first support ring positioned at least adjacent to the first bearing to prevent the first bearing from becoming dislodged from the float.

2. A liquid level gauge according to claim 1, wherein the float assembly further comprises:
a central tube having a wall with an outer surface and an inner surface defining a central bore; and
a first annular projection formed at a first location on the central tube, the first annular projection extending generally radially inwardly from the inner surface of the central bore;
wherein the first annular projection prevents the first support ring from sliding out of the central bore in a first axial direction.

3. A liquid level gauge according to claim 2, wherein the float assembly further comprises:
a second annular projection formed at a second location on the central tube and axially spaced from the first annular projection, the second annular projection extending generally radially inwardly from the inner surface of the central bore and being in proximity to the first annular projection;
a second support ring positioned in the inner bore between the first and second annular projections, the second annular projection preventing the first and second support rings from sliding out of the bore in a second axial direction; and
the first bearing being positioned between the first and second support rings to thereby retain the first bearing within the central bore between the first and second annular projections.

4. A liquid level gauge according to claim 3, wherein the float assembly further comprises:
third and fourth annular projections formed at a third and fourth locations, respectively, on the central tube and axially spaced from the first and second annular projections, the third and fourth annular projections extending generally radially inwardly from the inner surface of the central bore and being in proximity to each other;
third and fourth support rings positioned and retained between the third and fourth annular projections, respectively; and
a second bearing positioned in the central bore between the third and fourth support rings to thereby retain the second bearing within the central bore.

5. A liquid level gauge according to claim 4, wherein an outer diameter of the first and second bearings is greater than an inner diameter of at least the first and third annular projections.

6. A liquid level gauge according to claim 5, wherein an outer diameter of the first, second, third, and fourth support rings is greater than an inner diameter of the annular projections.

7. A liquid level gauge according to claim 6, wherein at least the first and second bearings are sufficiently resilient to slip past at least one of the annular projections during installation and spring back to a larger diameter after installation so that the support rings are retained between their respective projections.

8. A liquid level gauge according to claim 7, wherein the support rings are sufficiently resilient to slip past the annular projections during installation and spring back to a larger diameter after installation so that the support rings are retained between their respective annular projections.

9. A liquid level gauge according to claim 4, wherein the outer diameter of the first and second bearings is greater than an inner diameter of the first, second, third, and fourth annular projections.

10. A liquid level gauge according to claim 9, wherein at least the first and second bearings are sufficiently resilient to slip past at least one of the annular projections during installation and spring back to their original diameter after installation so that the support rings are locked between their respective projections.

11. A liquid level gauge according to claim 10, wherein an outer diameter of the first, second, third, and fourth support rings is greater than an inner diameter of the annular projections.

12. A liquid level gauge according to claim 11, wherein the support rings are sufficiently resilient to slip past the annular projections during installation and spring back to a larger diameter after installation so that the support rings are retained between their respective projections to thereby further retain the annular bearings in place.

13. A liquid level gauge according to claim 2, wherein the wall of the central tube is thin in cross section and the first annular projection is created by forming an annular groove in the outer surface of the wall to thereby deform the thin wall inwardly into the central bore.

14. A liquid level gauge according to claim 2, wherein the first support ring comprises a split ring that contracts to a dimension smaller than the first annular protrusion and expands to a dimension larger than the first annular protrusion to thereby retain the split ring within the central bore.

15. A liquid level gauge according to claim 2, wherein the first support ring comprises a solid resilient ring that deforms to a dimension smaller than the first annular protrusion and expands to a dimension larger than the first annular protrusion to thereby retain the resilient ring within the central bore.

16. A float assembly for use in a liquid level gauge having a vertical support tube that extends into a tank for measuring a level of liquid therein, the float assembly comprising:
a float adapted to surround the vertical support tube for sliding movement therealong in response to a change in liquid level within the tank, the float having a central axis that is adapted to be coincident with a longitudinal axis of the vertical support tube;
a central tube extending through the float and being coincident with the central axis thereof, the central tube having a wall with an outer surface and an inner surface defining a central bore that is adapted to surround the support tube;
first and second annular projections formed at first and second locations on the central tube, the annular projections extending generally radially inwardly from an inner surface of the central bore;
first and second support rings located within the central bore and retained between the annular projections; and
a first bearing having a first opening for slidably receiving the support tube and being positioned in the central bore between the first and second support rings to thereby retain the first bearing between the first and second annular projections.

17. A float assembly according to claim 16, and further comprising:
third and fourth annular projections formed at third and fourth locations, respectively, on the central tube and axially spaced from the first and second annular projections, the third and fourth annular projections extending generally radially inwardly from the inner surface of the central bore and being in proximity to each other;
third and fourth support rings retained within the third and fourth annular projections, respectively; and
a second bearing having a second opening for slidably receiving the support tube so that the float assembly slides linearly along the support tube, the second bearing being positioned in the central bore between the third and fourth support rings to thereby retain the second bearing between the third and fourth projections.

18. A float assembly according to claim 17, wherein an outer diameter of the first and second bearings is greater than an inner diameter of the first and third annular projections.

19. A float assembly according to claim 18, wherein an outer diameter of the first, second, third, and fourth support rings is greater than an inner diameter of the annular projections.

20. A float assembly according to claim 19, wherein at least one of the first and second bearings and the support rings are sufficiently resilient to slip past at least one of the annular projections during installation and spring back to a larger diameter after installation so that the support rings and/or the bearings are retained between their respective annular projections.
